(19) United States
(12) Patent Application Publication
(10) Pub. No.: US 2010/0146485 A1
(43) Pub. Date: Jun. 10, 2010

(54) Environment Abstraction of a Business Application and the Executing Operating Environment

(76) Inventor: Jochen Guertler, Karlsruhe (DE)

Correspondence Address: FISH & RICHARDSON, P.C., PO BOX 1022, MINNEAPOLIS, MN, 55440-1022, US

(21) Appl. No.: 12/332,027

(22) Filed: Dec. 10, 2008

(51) Int. Cl. G06F 9/44

(52) U.S. Cl. 717/124

(57) ABSTRACT

Methods and systems for dynamically relating features of an operating environment to features supported by an application for operating within the operating environment are disclosed. The methods and systems include dynamically identifying the features provided by the operating system, identifying the features supported by the application, and comparing those features to determine if the application is able to run within the operating environment. Further, the comparison identifies if optional features supported by the application are provided by the operating environment. Further, changes to one or more of the operating environment and the application are tracked so that those changes are recognized during subsequent comparisons.

### TECHNICAL FIELD

This disclosure relates to methods and system for dynamically relating features of an operating environment with the features supported by an application for operating within the operating environment. Particularly, the present disclosure includes identifying features provided by an operating environment, identifying features required and/or supported by an application, and determining whether the application may be run within the operating environment.

### BACKGROUND

Computer programs, which may also be referred to as an application (such as a business application), operate within an operating environment. In some instances, operating environments are computer operating systems, such as Microsoft Windows, by Microsoft Corporation of 1020 102nd Ave NE Bellevue, Wash. 98004. In some instances, the operating environment provides essential or necessary as well as optional operability or features available to one or more applications running in the operating environment. Typically, the features of an operating environment are known in advance, and the application is constructed or otherwise configured based on this advance information. That is, the application is specifically built based on the features known to be provided by the operating environment. Thus, there is a static relationship between the application and the operating environment. Should one or more features of the operating environment change and that change not be reflected in the application ahead of time, the application may function incompletely, incorrectly, or cease to function altogether in the operating environment.

### SUMMARY

An aspect of the present disclosure is directed to a computer-implemented method for dynamically determining compatibility between an operating environment and an application including reading an environment description file of the operating environment to determine one or more features provided by the operating environment; reading an application description file of the application to determine one or more features required by the application; comparing the one or more features provided by the operating environment to the one or more features required by the application; and enabling a feature of the application based on the comparison.

According to a further aspect, software for dynamically determining compatibility between an operating environment and an application may include machine-readable instructions operable when executed to read an environment description file of the operating environment to determine one or more features provided by the operating environment; read an application description file of the application to determine one or more features required by the application; compare the one or more features provided by the operating environment to the one or more features required by the application; and enable a feature of the application based on the comparison.

One or more of the aspects may include one or more of the following features. Information identifying the one or more features required by the application read from the application description file may be sent to an operating environment wrapper and wherein comparing the one or more features provided by the operating environment to the one or more features required by the application is performed by the operating environment wrapper. The operating environment may be launched via an operating environment wrapper and launching the application via an application wrapper. Reading the environment description file of the operating environment to determine the one or more features provided by the operating environment may be initiated by executing an operation of the operating environment wrapper. Reading the application description file of the application to determine the one or more features required by the application may be initiated by executing an operation of the application wrapper.

One or more of the aspects may additionally include one or more of the following features. At least one of the operating environment description file or the application file may be automatically updated to reflect a change to the one or more features provided by the operating environment or the one or more features supported by the applications, respectively. The application description file of the application may be read to determine one or more optional features supported by the application. The one or more features provided by the operating environment may be compared to the one or more optional features supported by the application to identify one or more additional features provided by the operating environment and supported by the application. A message may be displayed if the one or more features provided by the operating environment do not satisfy the one or more features required by the application.

One or more of the implementations may also include one or more of the following. The one or more features provided by the operating environment may be compared to the one or more features required by the application is performed prior to staring the application within the operating environment. Information identifying the one or more features required by the application read from the application description file may be sent to an operating environment wrapper. The comparison of the one or more features provided by the operating environment to the one or more features required by the application may be performed by the operating environment wrapper. The operating environment may be launched via an operating environment wrapper and operable when executed to launch the application via an application wrapper. At least one of the operating environment description file or the application file may be automatically updated to reflect a change to the one or more features provided by the operating environment or the one or more features supported by the applications, respectively. The application description file of the application may be read to determine one or more optional features supported by the application. The one or more features provided by the operating environment may be compared to the one or more optional features supported by the application to identify one or more additional features provided by the operating environment and supported by the application. A message may be displayed if the one or more features provided by the operating environment do not satisfy the one or more features required by the application. A feature of the application may be enabled based on the comparison comprises machine-readable instructions operable when executed to allow the application to launch. At least one of the environment description or the application description may be updated based on a software update. A feature of the application may be enabled based on a user authorization level.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates an example system for defining and conducting multiple term criteria searches in accordance with one implementation of the present disclosure.

FIG. 2 is a schematic representation of an example system for dynamically determining the features provided by an operating environment and features utilized by an application.

FIG. 3 is an example script of an application description.

FIGS. 4 and 5 show example screens of an example operating environment and an example application running therein.

### DETAILED DESCRIPTION

The present disclosure is related to relating capabilities of an application, such as a business application (or simply “BA”), to the capabilities provided by and/or supported by an operating environment. Particularly, the present disclosure provides systems and methods for dynamically relating features of an operating environment to features supported by an application for operating within the operating environment. As a result, a determination as whether the application is operable within the operating environment as well as additional features that may be provided to the application can be made. For the purposes of this description, the application will hereinafter be referred to as the BA, with the understanding that the present disclosure is applicable to any suitable application.

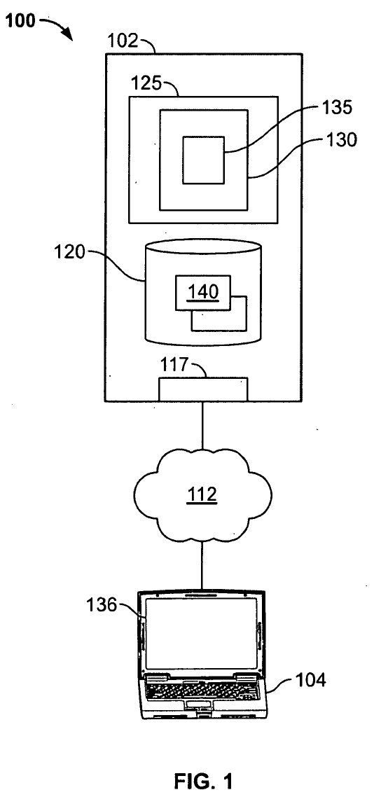

FIG. 1 illustrates an example system 100 for dynamically relating features of an operating environment to features supported by a BA for operating within the operating environment. System 100 may determine the features provided by the operating environment and the features supported by the BA to determine at least one of whether the BA is operable within the operating environment as well as any additional features beyond one or more minimum required features that may be supported by the BA. The system 100 may utilize a method for dynamically relating features of an operating environment to features supported by a BA. According to an example method within the scope of the disclosure, the system 100 may read an environment description file of the operating environment to determine one or more features provided by the operating environment and read an application description file of the BA to determine one or more features required by the BA. The system 100 may compare the one or more features provided by the operating environment to the one or more features required by the BA. Additionally, the system 100 may start the BA if the operating environment provides the one or more features required by the BA. The system 100 may also include operability to dynamically determine whether an operating environment is capable of running a BA therein as well as determining any additional features provided by the operating environment that may be used by the BA. Still further, the system 100 may also determine availability of features provided by the BA and/or supported by the operating environment based on a user's authorization level, e.g., administrator level access, security level access, entry level access, etc. Some access levels may provide features to the user that other access levels do not, even though one or more of the BA or operating environment is capable of providing those features.

System 100 may be a distributed client/server system that spans one or more networks, such as network 112. In such implementations, data may be communicated or stored in an encrypted format using any standard or proprietary encryption algorithm. But system 100 may be in a dedicated enterprise environment—across a local area network or subnet—or any other suitable environment without departing from the scope of this disclosure. The system 100 may include or be communicably coupled with a server 102, one or more clients 104, and network 112.

Server 102 comprises an electronic computing device operable to receive, transmit, process, and store data associated with system 100. Generally, FIG. 1 provides merely one example of computers that may be used with the disclosure. Each computer is generally intended to encompass any suitable processing device. For example, although FIG. 1 illustrates one server 102 that may be used with the disclosure, system 100 can be implemented using computers other than servers, as well as a server pool. Indeed, server 102 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 102 may be adapted to execute any operating system including Linux, UNIX, Windows Server, or any other suitable operating system. According to one embodiment, server 102 may also include or be communicably coupled with a web server and/or a mail server.

The server 102 may include local memory 120. Memory 120 may include any memory or database module and may take the form of volatile or non-volatile memory including, without limitation, magnetic media, optical media, random access memory (RAM), read-only memory (ROM), removable media, or any other suitable local or remote memory component. Illustrated memory 120 may include, among other items, a business application description, such as BA description 140b, described in more detail below. Further, the memory 120 may include an operating environment, such as operating environment 130, described below. Memory 120 may also include other types of data, such as environment and/or application description data, application data for one or more applications, as well as data involving VPN applications or services, firewall policies, a security or access log, print or other reporting files, HyperText Markup Language (HTML) files or templates, related or unrelated software applications or sub-systems, and others. Consequently, memory 120 may also be considered a repository of data, such as a local data repository from one or more applications.

According to some implementations, the BA description 140b may be in the form of one or more Structured Query Language (“SQL”) statements or scripts of a scripting language, a script language, or an extension language (hereinafter referred to as a “script language”). For example, the BA description 140b may be formatted, stored, or defined as various data structures in text files, extensible Markup Language (XML) documents, Virtual Storage Access Method (VSAM) files, flat files, Btrieve files, comma-separated-value (CSV) files, internal variables, or one or more libraries. Aside from XML, other example scripting languages may include JavaScript, Cascading Style Sheets (CSS), HTML, asynchronous JavaScript and XML (AJAX), as well as others. An example BA description 140b, shown below, is in the form of an XML script for a hypothetical domain, abc.com.

```
  <?xml version=“1.0” encoding=“utf-8”?>
  <Chip>
    <Id>com.abc.ecm.DocumentCHIP</Id>
    <Implementation type=“WebDynproJava”>
      <Component>com.abc.ecm.DocumentCHIPComp</Component>
      <DeployUnit>abc.com/tc~ccp~chips~coll~docuchip</DeployUnit>
    </Implementation>
    <Appearance>
      <Title>${title}</Title>
      <Description>${description}</Description>
      <Icon type=“relative” size=”small”>/webdynpro/resources/
abc.com/[...]/evt_BF20a.gif</Icon>
        <Icon type=“relative” size=”large”>/webdynpro/resources/
abc.com/[...]/evt_BF20b.gif</Icon>
      </Appearance>
      <Properties>
        <Property name=“com.abc.cpp.sharable”
        type=“fixed”>true</Property>
      </Properties>
      <Contracts>
        <Provide id=“IIndexable”
technical_contract=“com.abc.ccp.index.japi.IIndexable2”>
          <Implement />
        </Provide>
        <Provide id=“ILifecycleAware”
technical_contract=“com.abc.ccp.workspaceinfra.japi.ILifecycle”>
          <Portalservice key=“chip1serviceKey” />
        </Provide>
        <Consume id=“IMashable”
technical_contract=“com.abc.ccp.mashable.japi.IMashable” type=“inject”
required=“false”>
          <Inports>
          </Inports>
          <Outports>
          </Outports>
        </Consume>
        <Consume id=“ITaggable”
technical_contract=“com.abc.ccp.tagging.wdapi.ITagAccess”
type=“locate” />
      </Contracts>
      <ConfigurationSheets>
        <Sheet name=“config” type=“xml”/>
        <Sheet name=“ecm_config” type=“properties”>
          <Property name=“com.abc.ecm.document.ecm_location”/>
          <Property name=“com.abc.ecm.document.startupfolder”/>
        </Sheet>
      </ConfigurationSheets>
    </Chip>
```

Of course, it will be understood that the forgoing is for illustration purposes and is not meant to limit the scope of the disclosure. Put differently, the above example script is meant to help provide context and description and other scripts may implement functions and functionality disparate from it while remaining within the scope of the disclosure.

As shown, the first line of the example BA description includes a version identifier. Designated by “<Id>,” the example BA description also includes an identification element that contains a unique identifier for the example BA description. Designated by “<Implementation>,” an implementation element is defined. The implementation element supports a type attribute that denominates different UI implementations available for the BA. An appearance element, designated by “<Appearance>,” defines properties that may influence the appearance of the example BA description. A display icon may also be referenced in the appearance element. A properties element of the example BA description is designated by “<Properties>.” The properties element may include a set of generic properties represented as a list of name-value pairs. The example BA description may not evaluate the name-value pairs but may provide the name-value pairs to the operating environment wrapper, such as operating environment wrapper 204, described in more detail below. A contract element that defines the features encompassed by the business application is designated by “<Contracts>.” In other words, the contract element defines the features that the business application consumes or implements. The contract element may also include attributes that define how the business application consumes or utilizes features. The contract element may further include identifiers that identify which features are mandatory for the business application and/or an identifier that identifies optional features. The contract element may also include sub-elements designated by “<Provide>” and “<Consume>” 314 and 316. These sub-elements may define how features implemented by the business application may be identified. Configuration sheets that may identify configuration sheets for the BA description is defined is designated by “<ConfigurationSheets>.” The configuration sheets can be declared in this element but the content of the configuration sheets need not already exist. The end of the example BA description is designated by “</Chip>.”

Server 102 may also include processor 125. Processor 125 executes instructions and manipulates data to perform the operations of the server 102 and may be, for example, a central processing unit (CPU), a blade, an application specific integrated circuit (ASIC), or a field-programmable gate array (FPGA). Although FIG. 1 illustrates a single processor 125 in server 102, multiple processors 125 may be used according to particular needs and reference to processor 125 is meant to include multiple processors 125 where applicable. In the illustrated embodiment, processor 125 executes application 130.

Server 102 may also include interface 117 for communicating with other computer systems, such as clients 104, over network 112 in a client-server or other distributed environment. In certain embodiments, server 102 receives data from internal or external senders through interface 117 for storage in memory 120 and/or processing by processor 125. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals.

Network 112 facilitates wireless or wireline communication between computer server 102 and any other local or remote computer, such as clients 104. Network 112 may be all or a portion of an enterprise or secured network. In another example, network 112 may be a VPN merely between server 102 and client 104 across wireline or wireless link. Such an example wireless link may be via 802.11a, 802.11b, 802.11g, 802.20, WiMax, and many others. While illustrated as a single or continuous network, network 112 may be logically divided into various sub-nets or virtual networks without departing from the scope of this disclosure, so long as at least a portion of network 112 may facilitate communications between server 102 and at least one client 104. For example, server 102 may be communicably coupled to a repository 137 through one sub-net while communicably coupled to a particular client 104 through another. In other words, network 112 encompasses any internal or external network, networks, sub-network, or combination thereof operable to facilitate communications between various computing components in system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 112 may be a secure network accessible to users via certain local or remote clients 104.

Client 104 may be any computing device operable to connect or communicate with server 102 or network 112 using any communication link. At a high level, each client 104 includes or executes at least GUI 136 and comprises an electronic computing device operable to receive, transmit, process and store any appropriate data associated with system 100. It will be understood that there may be any number of clients 104 communicably coupled to server 102. Further, “client 104” and “user” may be used interchangeably as appropriate without departing from the scope of this disclosure. Moreover, for ease of illustration, each client 104 is described in terms of being used by one user. But this disclosure contemplates that many users may use one computer or that one user may use multiple computers. As used in this disclosure, client 104 is intended to encompass a personal computer, touch screen terminal, workstation, network computer, kiosk, wireless data port, smart phone, personal data assistant (PDA), one or more processors within these or other devices, or any other suitable processing device. For example, client 104 may be a PDA operable to wirelessly connect with an external or unsecured network. In another example, client 104 may comprise a laptop computer that includes an input device, such as a keypad, touch screen, mouse, or other device that can accept information, and an output device that conveys information associated with the operation of server 102 or clients 104, including digital data, visual information, or GUI 136. Both the input device and output device may include fixed or removable storage media such as a magnetic computer disk, CD-ROM, or other suitable media to both receive input from and provide output to users of clients 104 through the display, namely the client portion of GUIs or application interface 136.

GUI 136 comprises a graphical user interface operable to allow the user of client 104 to interface with at least a portion of system 100 for any suitable purpose, such as viewing application or other transaction data. For example, GUI 136 could present various views on business information that are tailored based on the abstraction of the underlying application or operating environment. Generally, GUI 136 provides the particular user with an efficient and user-friendly presentation of data provided by or communicated within system 100. GUI 136 may comprise a plurality of customizable frames or views having interactive fields, pull-down lists, and buttons operated by the user. GUI 136 may also present a plurality of portals or dashboards. For example, GUI 136 may display a secure webpage that allows users to input and define search parameters for one or more modules. It should be understood that the term graphical user interface may be used in the singular or in the plural to describe one or more graphical user interfaces and each of the displays of a particular graphical user interface. Indeed, reference to GUI 136 may indicate a reference to the front-end or a component of application 130, as well as the particular interface accessible via client 104, as appropriate, without departing from the scope of this disclosure. Therefore, GUI 136 contemplates any graphical user interface, such as a generic web browser or touch screen, that processes information in system 100 and efficiently presents the results to the user. Server 102 can accept data from client 104 via the web browser (e.g., Microsoft Internet Explorer or Netscape Navigator) and return the appropriate HTML or XML responses to the browser using network 112.

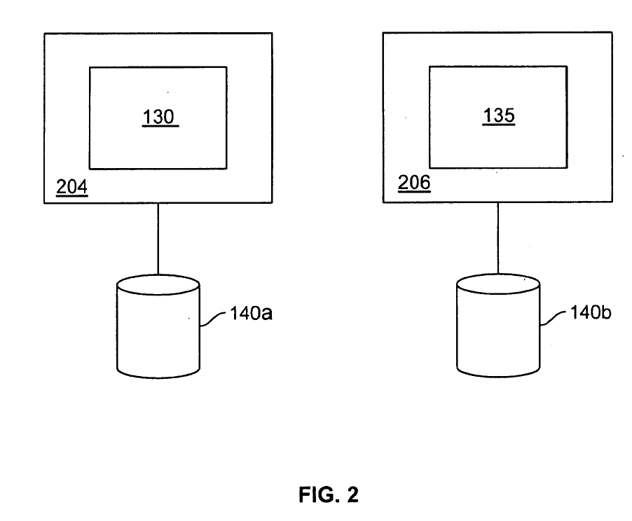

FIG. 2 shows an example operating environment 130 and an example BA 135 for running in the operating environment 130. In some implementations, the operating environment 130 is a computer program that may contain one or more features, services, functionalities, capabilities, etc., (collectively referred to hereinafter as “features”) that may be utilized by one or more applications running in the operating environment 130. The one or more applications, such as BA 135, are able to perform operations encompassed therein by using the features contained in the operating environment, such as operating environment 130.

Associated with each of the operating environment 130 and the BA 135 is an environment wrapper 204 and an application wrapper 206, respectively. The environment wrapper 204 may be a computer file or program used to call or begin running the operating environment 130. That is, as a result of the environment wrapper 204, the operating environment 130 may not be executed directly by a user. Rather, the environment wrapper 204 operates as a gateway for starting the operating environment 130. The environment wrapper 204 may also be capable of performing other functions or operations, such as triggering the start of one or more separate programs or executing a script of a script language. Example script languages may include XML, JavaScript, Cascading Style Sheets (CSS), HTML, asynchronous JavaScript and XML (AJAX), as well as others. The environment wrapper 204 may start the operating environment 130 before or after starting the one or more other programs or running the one or more scripts. In other implementations, the scripts or other programs triggered by the environment wrapper 204 may be incorporated within the environment wrapper 204. In still other implementations, one or more programs and/or scripts may be referenced within the environment wrapper 204 while other programs and/or scripts referenced by the environment wrapper 204 may be separate therefrom.

Among other functions the environment wrapper 204 may perform, the environment wrapper 204 is operable to assess the features supported or otherwise provided by the operating environment 130. The results of this assessment may be maintained in an environment description 140a. In some implementations, the environment description 140a may be a computer file. For example, the environment description 140a may be maintained in a script, a text file, or any other suitable file for maintaining information about the operating environment 130. However, the environment description 140a may be in any form from which the environment wrapper 204 is operable to read or to which the environment wrapper 204 is operable to write. According to some implementations, the environment description 140a may include the name of the operating environment 130, descriptive text, a version number of the operating environment 130, and a list of features provided by the operating environment 130. In some instances, the environment description 140a may identify one or more mandatory features that a program must support in order to run in the operating environment 130 while, optionally, identifying one or more optional features provided by the operating environment 130 that a program running thereon may utilize. In other implementations, the environment description 140a may include additional, fewer, or different information.

According to some implementations, the operating environment 130 may initially include a default description identifying the features of the operating environment 130. Over time the features of the operating environment 130 may change and, consequently, this list may change. For example, features of the operating environment 130 may be altered such as by updates made thereto that affect one or more aspects of the operating environment 130, the addition of features to and/or the removal of features from the operating environment 130, etc. Consequently, the environment description 140a may be dynamically updated to reflect the changing features of the operating environment 130. In some instances, the environment description 140a may be updated in real time as the features of the operating environment 130 change.

Similarly, the application wrapper 206 may also be a computer file or program separate from and used to start the BA 135 as well as perform one or more other actions. For example, the application wrapper 206 may be operable to run one or more other programs or scripts. The programs or scripts triggered by the application wrapper 206 may be separate entities referenced within the application wrapper 206 or the programs or scripts may be incorporated into the application wrapper 206. In still other implementations, one or more programs and/or scripts may be referenced within the application wrapper 206 while other programs and/or scripts referenced by the application wrapper 206 may be separate therefrom. A program or script executed by the application wrapper 206 may be operable to assess the features of the BA 135. Additionally, the BA 135 may not be directly executed by a user, but, rather, the BA 135 may be executed via the application wrapper 206.

Similar to the environment wrapper 204, by executing the one or more programs or scripts, the application wrapper 206 may be operable to assess features provided by the BA 135 and/or the features required by the BA 135 from an operating environment to allow the BA 135 to function. Further, the application wrapper 206 may also determine optional features supported by the BA 135 above the minimum features that the BA 135 requires in order to function within an operating environment. The required and optional features identified by the application wrapper 206 may be maintained in a BA description 140b. Similar to the environment description 140a, the BA description 140b may be a file and may be maintained in a script language. However, the BA description 140b may be maintained in any other suitable form. For example, the BA description 140b may be in any form from which the application wrapper 206 may read or to which the application wrapper 206 may write. Further, the environment description 140a and the BA description 140b may have the same or different forms.

In some implementations, the BA description 140b may include the name of the BA 135, descriptive text, a version number of the BA 135, and a list of features provided by the BA 135. For example, the BA description 140b may identify one or more mandatory features while also identifying one or more optional features provided by the BA 135. According to other implementations, the BA description 140b may include additional, fewer, or different information. An example BA description 140b is described above.

The application wrapper 206 may initially include a default description identifying the features of the BA 135. Further, over time these features may change, for example, as a result of changes to the BA. For example, new features may be added to the BA 135 while others may be removed. Alternately, some features may become modified. Further, the application wrapper 206 may be operable to identify these changes and update the BA description 140b accordingly. In some instances, the changes to the BA 135 may be identified and recorded into the BA description 140b in real time or otherwise dynamically. Thus, the BA description 140b may change over time to reflect the operating capabilities of the BA 135.

During operation, selecting the environment wrapper 204 may not only start the operating environment 130 along with performing any other scripts or programs therein incorporated or referenced thereby but also read the environment description 140a to determine the features of the operating environment 130. Similarly, in addition to running any scripts and programs included or referenced in the application wrapper 206, the environment wrapper 204 may also read the environment description 140a to determine the required and optional features needed or supported by the BA 135.

The application wrapper 206 may transmit the information obtained by reading the BA description 140b to the environment wrapper 204. The environment wrapper 204 or program referenced or incorporated therein may compare the information provided to the information obtained by reading the environment description 140a. As a result, the environment wrapper 204 (or program referenced therein) may determine: 1) whether the operating environment 130 supports the minimum requirements required by the BA 135 in order to run; and 2) whether the operating environment 130 provides one or more optional features supported by the BA 135. In other implementations, the information from the environment description 140a may be transmitted to the application wrapper 206 for comparison. In some instances, if the operating environment 130 does not support the minimum requirements required by the BA 20, the BA 135 will be prevented from starting. In some implementations in which the BA 135 is prevented from starting when the minimum requirements are not supported, hints or warning messages may be provided to the user.

If the operating environment 130 supports the minimum needed features of the BA 135, the BA 135 is permitted to start. If, in addition to the minimum requirements, the operating environment 130 supports one or more optional features, the BA 135 will start with those additional features enabled. As indicated above, the forms of the environment description and BA description and the information provided therein may be different. In such cases, the environment wrapper 204 or program referenced or included therein may be operable to receive and understand both types of information to perform the comparison. While in some implementations, the comparison of description information may occur prior to launching the application, the comparison may alternately be performed sometime after the program has started to launch. Further, the operating environment 130 may adapt the BA 135 based on the comparison in a manner transparent to the BA 135. In other instances, the BA 135 may be configured based on the comparison using logic provided in the BA 135.

In some instances, the operating environment 130 or BA 135 may be altered to add, remove, or change features provided or supported thereby. This change in the functionality of the operating environment 130 or BA 135 may be immediately reflected in the environment description 140a or BA description 140b by additions made thereto in real time. Alternately, the changes in functionality may be made some time later, such as when the operating environment 130 or BA 135 is terminated. Consequently, the features provided or supported by the operating environment 130 or BA 135 track.

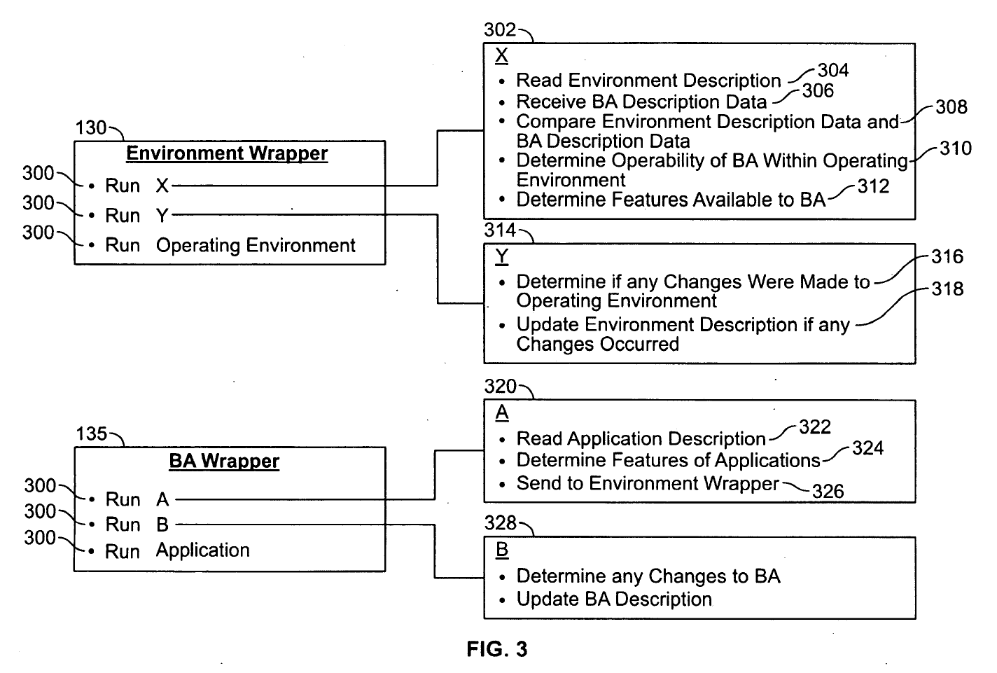

FIG. 3 shows schematic representations of an example environment wrapper 130 and an example application wrapper 206 according to one example implementation. As illustrated, these example wrappers 204, 206 include various operations 300. These operations 300 may be individual scripts, references to scripts, programs, or references to programs. Further, although only three operations 300 are illustrated in each of the wrappers 204, 206, additional or fewer operations 300 may be included. Further, the operations 300 may have more, fewer, or different functions than those described below.

One of the operations 300 is identified as “Run X.” As further shown, some of the processes that may be encompassed by “Run X” are shown at 302. Thus, when executed, “Run X” is operable to read the environment description (as indicated at 304), such as environment description 140a, described above, to determine the features of the associated operating environment, such as operating environment 130. As explained, this information may be indicative of what features the operating environment can provide to applications, such as BA 135, described above, running in the operating environment. Once “Run X” is executed, one or more aspects of the functionality of “Run X” may remain running. For example, “Run X” may continue to receive application description information, such as information read from BA description 140b. At 306, this application description information may be received and compared (at 308) to the environment description information. As explained above, such a comparison may determine whether the application is supported by the operating environment (at 310) and, optionally, additional features that may be supported (at 312).

Operation 300 labeled “Run Y” may execute a program or script, shown at 314, that is operable to determine if any changes have been made to the operating environment (at 316) and, if so, update the environment description (at 318), such as environment description 140a, to reflect those changes. Updating the environment description may be performed automatically once a change is detected.

The operations 300 labeled “Run A” and “Run B” may have similar functionality. For example, as shown 320, Run A may be operable to read an application description (at 322), such as BA description 140b, and determine the features required by the application in order to run in the operating environment (at 324). At 326, the information read from the application description is sent to the environment wrapper 204 to perform a comparison, such as the comparison described above. Further, illustrated at 328, the operation 300 “Run B” may have functionality to determine whether changes were made to the features supported or required by the application and update the application description accordingly.

Although functionality is shown as being part of one program referenced by the application wrapper 206 or environment wrapper 204, each individual function may be a separate script referenced or incorporated in the application wrapper 206 or environment wrapper 204 or a separate program referenced or incorporated therein. As indicated above, the example illustrated in FIG. 3 is merely one possible example of any number of other examples within the scope of this disclosure.

A system, such as system 100, permits the behavior of an application to be dynamically adapted when executed in an operating environment. Further, according to some implementations, changes to the features of an operating environment while running an application may be recognized and dynamically reflected in the running application. For example, if a feature is added to an operating environment and is a feature supported by the running application, the new feature may be made available immediately while the application continues to run. Further, system 100 ensures a consistent and complete environment by comparing both the environment description and the application description. If the environment description indicates that the necessary features required by the application and indicated in the application description are not present, then the application can be prevented from starting. Further, a warning message may be presented to a user that one or more of the features required by the application are not supported by the operating environment. Consequently, such a system saves time needed to otherwise support the operating environment or application running therein as well as reduces user frustration because the applications running in the operating environment will provide only those features supported by both the operating environment and application.

As a result, an application can be portable to different operating environments without having to be specifically tailored to each operating environment in advance. That is, a different version of an application would not have to be written specifically for each operating environment. Example operating environments may include different Internet web browsers, such as Internet Explorer by Microsoft, Corp.; Firefox by Mozilla Corp.; Safari by Apple of 1 Infinite Loop, Cupertino, Calif. 95014; etc. Alternately, an operating environment within the scope of the disclosure may be an operating environment using proprietary or some other type of software.

Further, the interoperability of an application and operating environment, as described herein, may allow applications to run in different operating environments without making changes to the applications. Example operating environments may include an Internet browser or browser-based operating environment, an operating system, such as Microsoft Windows, as well as operating environments provided on mobile devices. Other operating environments may include an “L-Shape,” such as an HTML-Business (HTMLB) based user interface or AJAX-based portal. However, other operating environments are within the scope of this disclosure. Additionally, the described interoperability is applicable to applications running on different server platforms as well as applications running in portal.

An example implementation may provide the following. An application, such as BA 135, may be able to manipulate text created by the operating environment, such as operating environment 130. For example, the application may be operable not only to display or not display a default or “fixed” text provided by the operating environment but also change the displayed text to reflect a current state of the application. Navigation selections within either the application or operating environment may be communicated to the other to cause an associated functionality to occur. For example, selecting a menu item in the operating environment may be communicated to the application to cause the associated response therein and vice versa. For some navigation, there may be a possibility of defining parameters and passing those defined parameters to a navigation target. In some instances, the navigation target could be defined by relative or absolute Uniform Resource Locators (“URLs”) or may be more abstract definition. The abstract definition may use a specific operation of a business object.

Also, an event-based communication channel between one or more applications and the operating environment may be provided as well as an event-based communication channel between one or more applications. Some applications may be operable to provide links to help documentation. The operating environment may be able to display such a help link in a help center location. The manner in which such a help center is displayed may depend on the operating environment. In some instances, an application may be operable to trigger visualization of a help link within the operating environment or to open and/or close the help center of the operating environment. In still other instances, the help center may be operable to turn on or off help texts within the application. Window handling may be provided by a particular service of the operating environment.

The operating environment may be operable to display messages created within an application within a central message area of the application. In some instances, the operating environment defines the manner in which the messages are displayed. An operating environment may support several applications running at once. Thus, displayed messages may be identified with the associated application, providing a clear indication to the user. Also, the operating environment may be operable to access search results from an application as well as trigger a search within the application. An application may be operable to extend a menu within the operating environment, for example, a menu associated or otherwise related to the application. In some instances, the operating environment may provide different levels of menus related to the application. For example, based on the operability of the application, one or more menu items within menus of the operating environment may become selectable or unselectable (i.e., grayed out or not otherwise selectable by a user).

In some instances, the operating environment may be operable to control an application running therein but does not necessarily mean that application sessions are directly handled by the operating environment. Rather, the operating environment may inform the running application that an application session should be created or destroyed.

In other implementations, an application may not directly access an authentication mechanism of the operating environment. Further, access to user information, such as a user ID, user name, user passwords, user roles, or user permissions, may be defined within the operating environment. In some implementations, only certain applications may be permitted to use certain features provided by the operating environment. An application may request the use of one or more of such features to the operating environment.

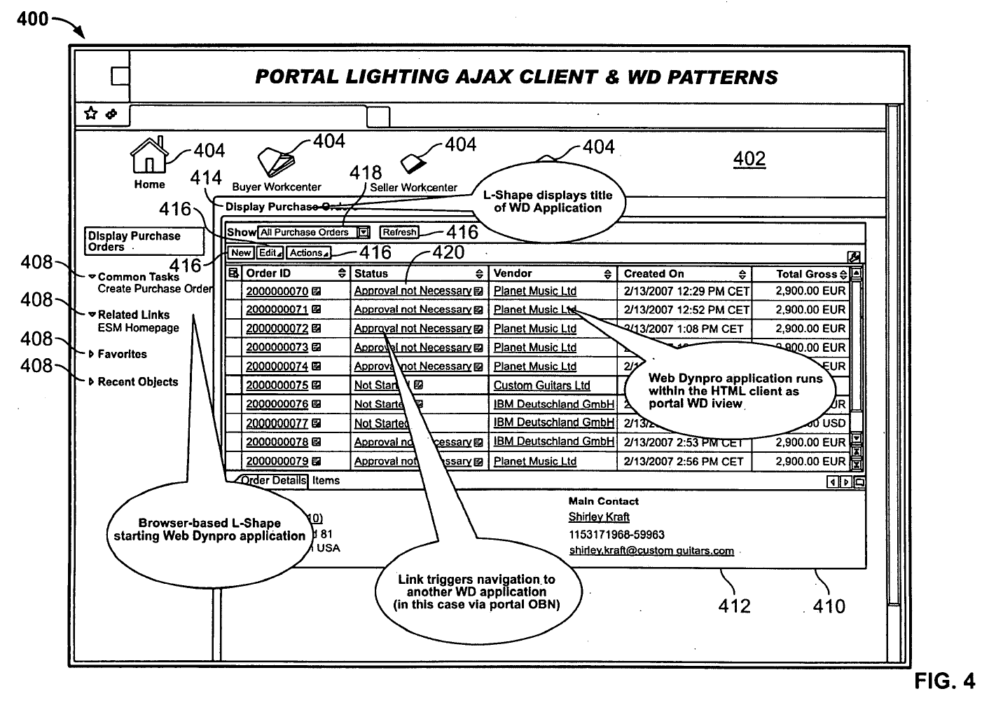

An example L-shape 300 is shown in FIG. 4. The L-shape 500 is an implementation of the operating environment having a horizontal bar 402 with selectable icons 404 thereon. Selecting one or more of the icons 404 may cause the operating environment to perform an associated function. The L-shape 400 also includes a vertical bar 406 that also includes selectable icons 408 thereon. Selecting the icons 408 may execute an associated function. The L-shape 400 flanks two sides of an instance of a business application 410. As the illustrated implantation, the business application 410 runs within the L-shape 400, which forms a portal of an Internet browser. The business application 410 is provided in a window 412 that includes a title 414 displayed by the L-shape 400. The business application 410 may include one or more selectable buttons and/or pull-down lists, such as buttons 416 and pull-down list 418. The business application 410 also includes linked text 420. In some instances, selecting the linked text 420 may trigger navigation to another business application.

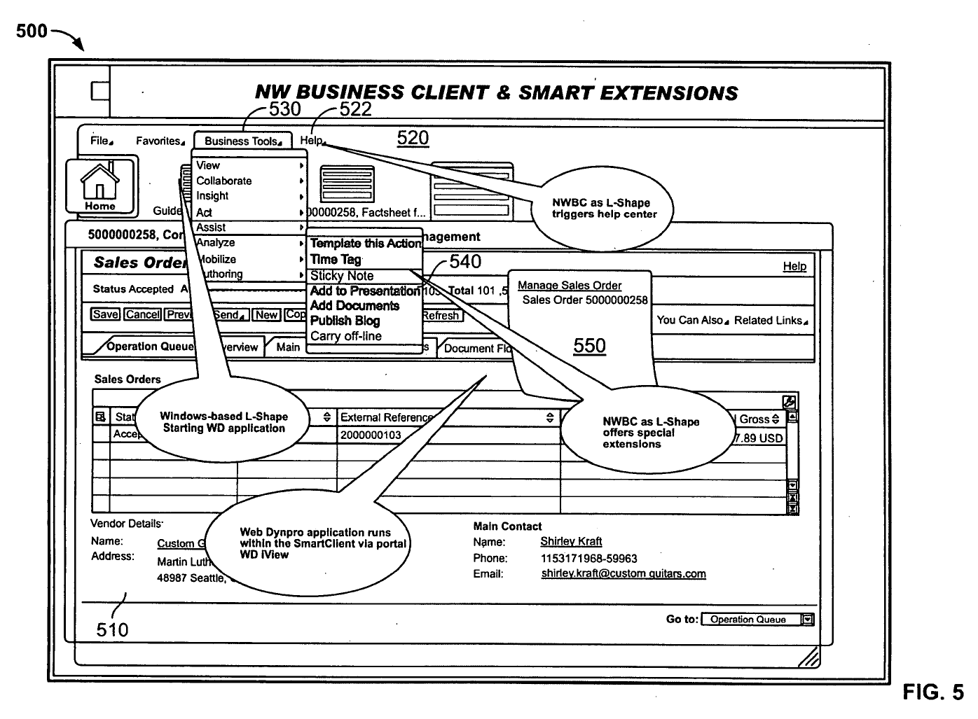

FIG. 5 shows another example implementation. An L-shape 500 and a business application 510 running in the L-shape 500 are shown. The L-shape 500 includes a tool bar 520. A help element 522 provided on the tool bar 520 may trigger a help center when selected. The help center may include one or more items specific to the business application 510. The help center may also include items specific to operating environment, e.g., L-shape 500. A Business Tools element 530 may also be included on the tool bar 520. The Business Tools element 530 may include a list of features operable within the business application 510. Some features provided in a list when the Business Tools element 530 is selected may be grayed out or otherwise unselectable, such as feature 540. These grayed out features may correspond to the optional features supported by the business application 510 but not provided by operating environment. A note feature 550 may be a feature provided by the L-shape 500 that can be customized for the particular business application running therein, such as business application 510.

While the present disclosure uses a plurality of flowcharts and accompanying descriptions to illustrate the example techniques associated with the various disclosed methods and techniques, environment 100 contemplates using or implementing any suitable technique for performing these and other tasks. It will be understood that these techniques are for illustration purposes only and that the described or similar techniques may be performed at any appropriate time, including concurrently, individually, or in combination. In addition, many of the steps in these flowcharts may take place simultaneously and/or in different orders than as shown and described. Moreover, environment 100 may use processes and methods with additional, fewer, and/or different steps, so long as the processes and methods remain appropriate.

Although this disclosure has been described in terms of certain implementation and generally associated methods, alterations and permutations of these implementations and methods will be apparent to those skilled in the art. Accordingly, other implementations are within the scope of the following claims.

What is claimed is:

1. A computer-implemented method for dynamically determining compatibility between an operating environment and an application comprising:
reading an environment description of the operating environment to determine one or more features provided by the operating environment;
reading an application description of the application to determine one or more features required by the application;
comparing the one or more features provided by the operating environment to the one or more features required by the application; and
dynamically enabling a feature of the application based on the comparison.

2. The method of claim 1 further comprising sending information identifying the one or more features required by the application read from the application description file to an operating environment wrapper and wherein comparing the one or more features provided by the operating environment to the one or more features required by the application is performed by the operating environment wrapper.

3. The method of claim 1 further comprising launching the operating environment via an operating environment wrapper and launching the application via an application wrapper.

4. The method of claim 3, wherein reading the environment description file of the operating environment to determine the one or more features provided by the operating environment is initiated by executing an operation of the operating environment wrapper.

5. The method of claim 3, wherein reading the application description file of the application to determine the one or more features required by the application is initiated by executing an operation of the application wrapper.

6. The method of claim 1 further comprising automatically updating at least one of the operating environment description file or the application file to reflect a change to the one or more features provided by the operating environment or the one or more features supported by the applications, respectively.

7. The method of claim 1 further comprising reading the application description file of the application to determine one or more optional features supported by the application.

8. The method of claim 7 further comprising comparing the one or more features provided by the operating environment to the one or more optional features supported by the application to identify one or more additional features provided by the operating environment and supported by the application.

9. The method of claim 1 further comprising displaying a message if the one or more features provided by the operating environment do not satisfy the one or more features required by the application.

10. A system for dynamically determining compatibility between an operating environment and an application, the system comprising:
means for reading an environment description file of the operating environment to determine one or more features provided by the operating environment;
means for reading an application description file of the application to determine one or more features required by the application;
means for comparing the one or more features provided by the operating environment to the one or more features required by the application; and
means for enabling a feature of the application based on the comparison.

11. The system of claim 10 further comprising means for sending information identifying the one or more features required by the application read from the application description file to an operating environment wrapper and wherein comparing the one or more features provided by the operating environment to the one or more features required by the application is performed by the operating environment wrapper.

12. The system of claim 10 further comprising means for launching the operating environment via an operating environment wrapper and means for launching the application via an application wrapper.

13. The system of claim 10 further comprising means for automatically updating at least one of the operating environment description file or the application file to reflect a change to the one or more features provided by the operating environment or the one or more features supported by the applications, respectively.

14. The system of claim 10 further comprising means for reading the application description file of the application to determine one or more optional features supported by the application.

15. The system of claim 14 further comprising means for comparing the one or more features provided by the operating environment to the one or more optional features supported by the application to identify one or more additional features provided by the operating environment and supported by the application.

16. A computer program product for dynamically determining compatibility between an operating environment and an application, the computer program product comprising a tangible storage medium storing computer-readable instructions operable when executed to:
read an environment description file of the operating environment to determine one or more features provided by the operating environment;
read an application description file of the application to determine one or more features required by the application;
compare the one or more features provided by the operating environment to the one or more features required by the application; and
dynamically enable a feature of the application based on the comparison.

17. The computer program product of claim 16, wherein the comparison of the one or more features provided by the operating environment to the one or more features required by the application is performed prior to staring the application within the operating environment.

18. The computer program product of claim 16, the instructions further operable when executed to send information identifying the one or more features required by the application read from the application description file to an operating environment wrapper and wherein the comparison of the one or more features provided by the operating environment to the one or more features required by the application is performed by the operating environment wrapper.

19. The computer program product of claim 16, the instructions further operable when executed to launch the operating environment via an operating environment wrapper and operable when executed to launch the application via an application wrapper.

20. The computer program product of claim 16, the instructions further operable when executed to automatically update at least one of the operating environment description file or the application file to reflect a runtime change to the one or more features provided by the operating environment or the one or more features supported by the applications, respectively.

21. The computer program product of claim 16, the instructions further operable when executed to read the application description file of the application to determine one or more optional features supported by the application.

22. The computer program product of claim 16, the instructions further operable when executed to compare the one or more features provided by the operating environment to the one or more optional features supported by the application to identify one or more additional features provided by the operating environment and supported by the application.

23. The computer program product of claim 22, the instructions further operable when executed to display a message if the one or more features provided by the operating environment do not satisfy the one or more features required by the application.

24. The computer program product of claim 16, wherein enabling a feature of the application based on the comparison comprises allowing the application to launch.

25. The computer program product of claim 16, the instructions further operable when executed to update at least one of the environment description or the application description based on a software update.

26. The computer program product of claim 15, the instructions further operable when executed to enable a feature of the application based on a user authorization level.
